(19) United States
(12) Patent Application Publication
(10) Pub. No.: US 2014/0240254 A1
(43) Pub. Date: Aug. 28, 2014

(54) ELECTRONIC DEVICE AND HUMAN-COMPUTER INTERACTION METHOD

(71) Applicant: HON HAI PRECISION INDUSTRY CO., LTD., New Taipei (TW)

(72) Inventor: YI-AN CHEN, New Taipei (TW)

(73) Assignee: HON HAI PRECISION INDUSTRY CO., LTD., New Taipei (TW)

(21) Appl. No.: 14/181,630

(22) Filed: Feb. 15, 2014

(30) Foreign Application Priority Data
Feb. 26, 2013 (TW) 102106622

(51) Int. Cl. G06F 3/01

(52) U.S. Cl. CPC G06F 3/017
USPC 345/173

(57) ABSTRACT

An electronic device includes a base member and a display member rotatably coupled to the base member. A keyboard and a touchpad are located on a working surface of the base member. When two spaced points of the touchpad are pressed and the touchpad simultaneously detects a slide touch made along a direction substantially perpendicular to a straight line determined by the two spaced points of the touchpad, the touchpad recognizes the slide touch as a scroll operation on a scroll wheel of a mouse. A human-computer interaction method is also provided.

### REFERENCE TO RELATED APPLICATIONS

This application claims all benefits accruing under 35 U.S.C. §119 from Taiwan Patent Application No. 102106622, filed on Feb. 26, 2013 in the Taiwan Intellectual Property Office. The contents of the Taiwan Application are hereby incorporated by reference.

### BACKGROUND

1. Technical Field

The disclosure generally relates to electronic devices, and particularly relates to electronic devices having a touchpad and human-computer interaction methods.

2. Description of Related Art

Many notebook computers use touchpads as a “cursor navigator” as well as a component for selecting functions such as “select” and “confirm”. However, the touchpads are often small and incapable of recognizing more complex touch operations.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an embodiment of an electronic device.

FIG. 2 is a block diagram of an embodiment of the electronic device of FIG. 1.

FIG. 3 is a schematic view of an example of simulating a scroll wheel of a mouse by the electronic device of FIG. 1.

FIG. 4 is a flowchart of an embodiment of a human-computer interaction method implemented by the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

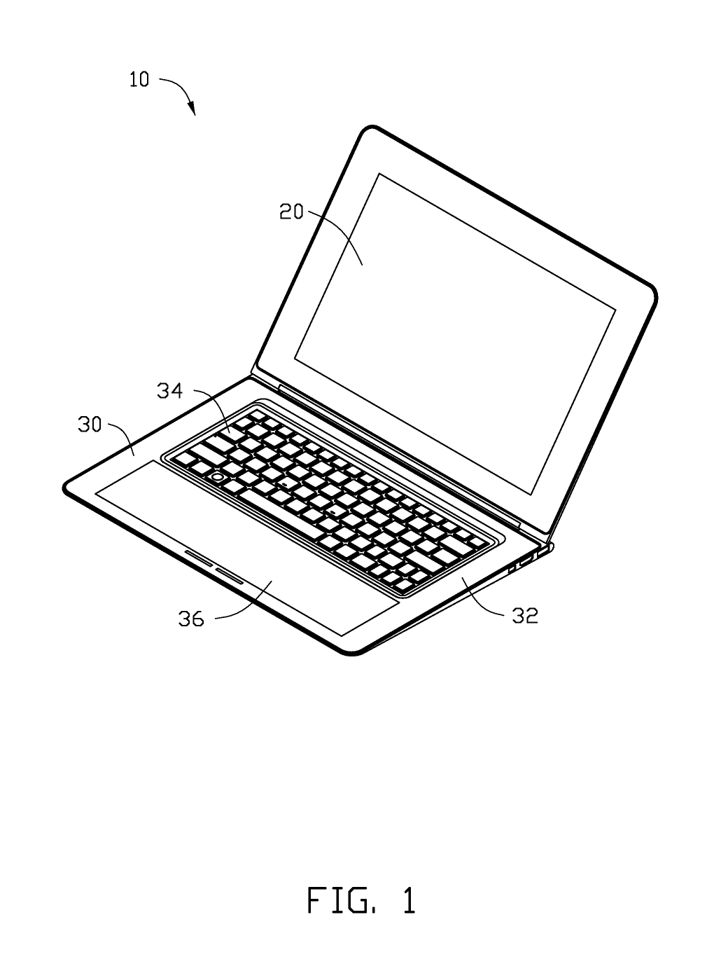

FIG. 1 is a schematic view of an embodiment of an electronic device 10. The electronic device 10 can be, but is not limited to, a notebook computer, a tablet computer, a gaming device, a DVD player, a radio, a television, a personal digital assistant (PDA), a smart phone, or any other type of portable or non-portable electronic device.

In one embodiment, the electronic device 10 includes a display member 20 rotatably coupled to a base member 30 to enable variable positioning of the display member 10 relative to the base member 30. A keyboard 34 and a touchpad 36 are located on a working surface 32 of the base member 30. In the illustrated embodiment, the touchpad 36 is located in front of the keyboard 34. In some embodiments, the touchpad includes a touch-sensitive surface which is made from carbon nanotubes.

In one embodiment, a length of the touchpad 36 is greater than 18 centimeters (cm), so that the touchpad 36 is suitable for two-hand operation by a user of the electronic device 10. The length of the touchpad 36 is substantially the same as the length of the keyboard 34. In other embodiments, the length of the touchpad 36 is substantially the same as the length of the base member 30.

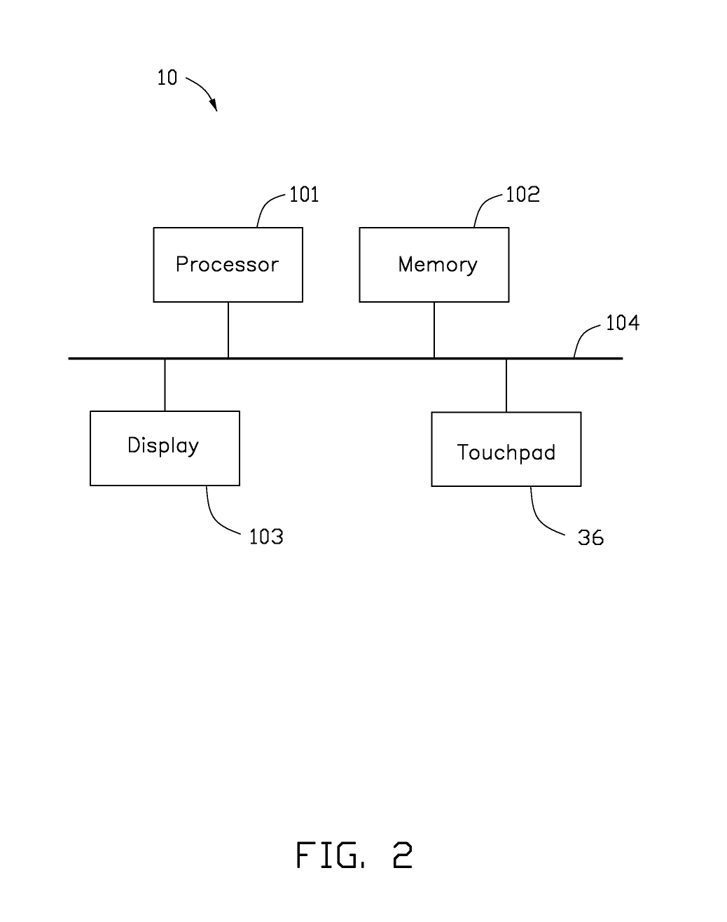

FIG. 2 shows a block diagram of an embodiment of the electronic device 10. The electronic device 10 further includes at least one processor 101, a suitable amount of memory 102, and a display 103. Of course, the electronic device 10 may include additional elements, components, modules, and be functionality configured to support various features that are unrelated to the subject matter described here. In practice, the elements of the electronic device 10 may be coupled together via a bus or any suitable interconnection architecture 104.

The processor 101 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here.

The memory 102 may be realized as RAM memory, flash memory, EPROM memory, EEPROM memory, registers, a hard disk, a removable disk, a CD-ROM, or any other form of storage medium known in the art. The memory 102 is coupled to the processor 101 such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 103 is suitably configured to enable the electronic device 10 to render and display various screens, GUIs, GUI control elements, menus, texts, or images, for example. Of course, the display 103 may also be utilized for the display of other information during the operation of the electronic device 10, as is well understood. The display 103 can be located in the display member 20.

When two spaced points of the touchpad 36 are pressed by a user and the touchpad 36 simultaneously detects a slide touch made along a direction substantially perpendicular to a straight line determined by the two spaced points of the touchpad 36, the touchpad 36 may recognize the slide touch as a scroll operation on a scroll wheel of a mouse. Thus, a scroll wheel of a mouse is simulated by the touchpad 36 for user input.

In some embodiments, the touchpad 36 may recognize a press touch made with respect to one of the two spaced points of the touchpad 36 as a press operation on a right button of a mouse and a press touch made with respect to another of the two spaced points of the touchpad 36 as a press operation on a left button of a mouse.

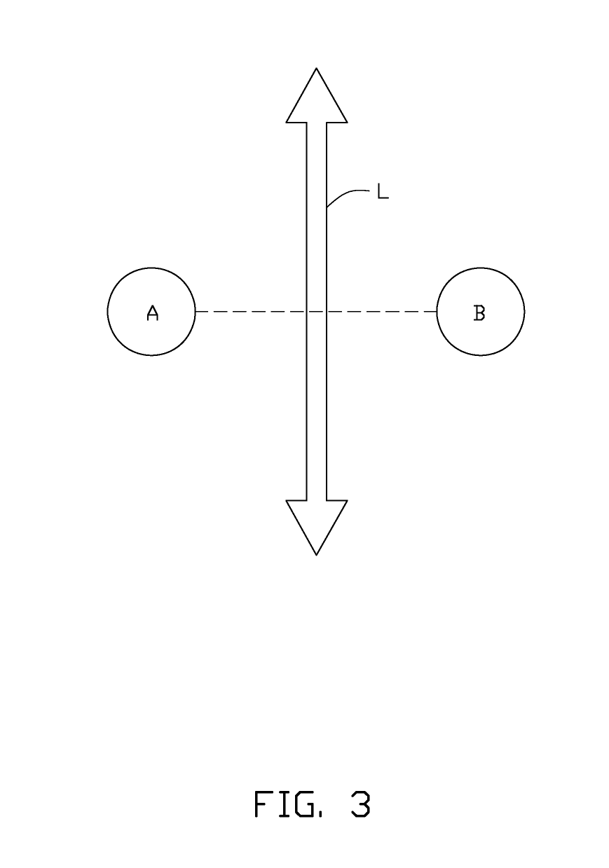

FIG. 3 shows a schematic view of an example of simulating a scroll wheel of a mouse by the touchpad 36. Two spaced points A and B of the touchpad 36 are pressed and simultaneously a slide touch L is made along a direction substantially perpendicular to a straight line determined by the two spaced points A and B of the touchpad 36. The slide touch L is recognized as a scroll operation on a scroll wheel of a mouse.

In one embodiment, a distance of the two spaced points A and B of the touchpad 36 are required to be greater than a predetermined distance. If a distance of the two spaced points A and B is not greater than the predetermined distance, the touchpad 36 will not detect whether the slide touch L is made and will not simulate a scroll wheel of a mouse. The display 103 may provide a GUI to allow a user to define the predetermined distance, such as 5 centimeters.

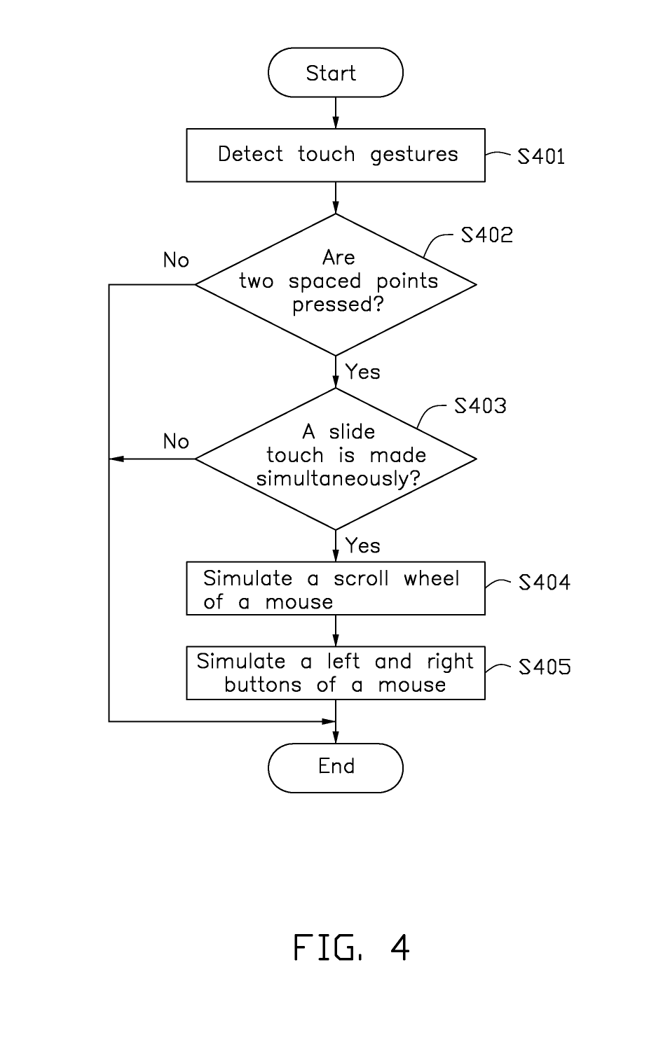

FIG. 4 shows a flowchart of one embodiment of a human-computer interaction method. The method includes the following steps.

In step S401, the touchpad 36 detects touch gestures input by the user.

In step S402, the touchpad 36 detects whether two spaced points of the touchpad 36 are pressed. If the two spaced points of the touchpad 36 are pressed, the flow proceeds to step S403. Otherwise, the flow ends.

In step S403, the touchpad 36 detects whether a slide touch is simultaneously made along a direction substantially perpendicular to a straight line determined by the two spaced points of the touchpad 36. If there is a slide touch which is simultaneously made along a direction substantially perpendicular to a straight line determined by the two spaced points of the touchpad 36, the flow proceeds to step S404. If there is no such a slide touch, the flow ends.

In step S404, the touchpad 36 recognizes the slide touch as a scroll operation on a scroll wheel of a mouse.

In step S405, the touchpad 36 recognizes a press touch made with respect to one of the two spaced points of the touchpad 36 as a press operation on a right button of a mouse and a press touch made with respect to another of the two spaced points of the touchpad 36 as a press operation on a left button of a mouse.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

What is claimed is:

1. An electronic device, comprising:
a base member;
a display member rotatably coupled to the base member; and
a keyboard and a touchpad located on a working surface of the base member;
wherein when two spaced points of the touchpad are pressed and the touchpad simultaneously detects a slide touch made along a direction substantially perpendicular to a straight line determined by the two spaced points of the touchpad, the touchpad is configured to recognize the slide touch as a scroll operation on a scroll wheel of a mouse.

2. The electronic device of claim 1, wherein the touchpad is further configured to recognize a press touch made with respect to one of the two spaced points of the touchpad as a press operation on a right button of a mouse and a press touch made with respect to another of the two spaced points of the touchpad as a press operation on a left button of a mouse.

3. The electronic device of claim 1, wherein a distance of the two spaced points of the touchpad is greater than a predetermined distance.

4. The electronic device of claim 3, wherein the display member comprises a display configured to provide a graphic user interface (GUI) to allow a user to define the predetermined distance.

5. The electronic device of claim 1, wherein the touchpad is located in front of the keyboard.

6. The electronic device of claim 1, wherein the touchpad is suitable for two-hand operation by a user of the electronic device.

7. The electronic device of claim 1, wherein a length of the touchpad is substantially the same as a length of the keyboard.

8. The electronic device of claim 1, wherein a length of the touchpad is substantially the same as a length of the base member.

9. The electronic device of claim 1, wherein the touchpad comprises a touch-sensitive surface made from carbon nanotubes.

10. A human-computer interaction method implemented in an electronic device, the electronic device comprising a base member, a display member rotatably coupled to the base member, a keyboard and a touchpad located on a working surface of the base member, the human-computer interaction method comprising:
detecting whether two spaced points of the touchpad are pressed and simultaneously a slide touch is made along a direction substantially perpendicular to a straight line determined by the two spaced points of the touchpad; and
when the two spaced points of the touchpad are pressed and simultaneously a slide touch is made along the direction substantially perpendicular to the straight line determined by the two spaced points of the touchpad, recognizing the slide touch as a scroll operation on a scroll wheel of a mouse.

11. The human-computer interaction method of claim 10, further comprising:
recognizing a press touch made with respect to one of the two spaced points of the touchpad as a press operation on a right button of a mouse; and
recognizing a press touch made with respect to another of the two spaced points of the touchpad as a press operation on a left button of a mouse.

12. The human-computer interaction method of claim 11, further comprising determining whether a distance of the two spaced points of the touchpad is greater than a predetermined distance.

13. The human-computer interaction method of claim 12, further comprising providing a graphic user interface (GUI) to allow a user to define the predetermined distance.

14. The human-computer interaction method of claim 10, wherein the touchpad is located in front of the keyboard.

15. The human-computer interaction method of claim 10, wherein the touchpad is suitable for two-hand operation by a user of the electronic device.

16. The human-computer interaction method of claim 10, wherein a length of the touchpad is substantially the same as a length of the keyboard.

17. The human-computer interaction method of claim 10, wherein a length of the touchpad is substantially the same as a length of the base member.

18. The human-computer interaction method of claim 10, wherein the touchpad comprises a touch-sensitive surface made from carbon nanotubes.
